(19) United States
(12) Patent Application Publication
(10) Pub. No.: US 2013/0151535 A1
(43) Pub. Date: Jun. 13, 2013

(54) DISTRIBUTED INDEXING OF DATA

(71) Applicants: Dariusz Dusberger, Irvine, CA (US); Bradley Denney, Irvine, CA (US)

(72) Inventors: Dariusz Dusberger, Irvine, CA (US); Bradley Denney, Irvine, CA (US)

(73) Assignee: CANON KABUSHIKI KAISHA, Tokyo (JP)

(21) Appl. No.: 13/315,497

(22) Filed: Dec. 9, 2011

(51) Int. Cl. G06F 17/30

(52) U.S. Cl. 707/747; 707/741; 707/E17.052; 707/E17.049

(57) ABSTRACT

Indexing a data set of objects, where the data set is partitioned into plural work units with plural objects and distributed to multiple data process nodes. Each data processing node maps the plural objects in corresponding work units into respective ones of given sub-indexes. A composite index is constructed for the objects in the data set by reducing the mapped objects, where reducing the mapped objects is distributed among multiple data processing nodes.

### FIELD

The present disclosure relates to distributed indexing of data, and more particularly relates to a scalable and distributed framework for indexing data such as high-dimensional data.

### BACKGROUND

In the field of data indexing, it is common to create an index for performing a search such as a K-Nearest Neighbor search. For example, an index may be created using a mapping function which divides the data into sets and a reducing function which aggregates the mapped data to get a final result.

Often, a K-Nearest Neighbor algorithm is used to perform a K-Nearest Neighbor search. For example, when searching for an image, K images are identified which have similar features to the features of the query image. Rather than exhaustively searching an entire database, K-Nearest Neighbor search techniques typically involve dividing data into smaller data sets of common objects and searching the smaller data sets. In some cases, a smaller data set can be ignored in the search, if the smaller set is sufficiently distant from a query object.

### SUMMARY

One shortcoming of existing data indexing and searching methods is that they are typically time consuming and require extensive resources, particularly when the data set to be indexed is large and the data is high-dimensional. In addition, existing data indexing methods do not ordinarily provide a framework for creating different types of indexes.

The foregoing situation is addressed by distributing a data set which has been partitioned to multiple data processing nodes for mapping and reducing.

Thus, in an example embodiment described herein, a data set of objects is indexed by partitioning the data set into plural work units each with plural objects. The plural work units are distributed to respective ones of multiple data processing nodes, where each data processing node maps the plural objects in corresponding work units into respective ones of given sub-indexes. A composite index is constructed for the objects in the data set by reducing the mapped objects, where reducing the mapped objects is distributed among multiple data processing nodes.

In an example embodiment also described herein, a data set of objects is indexed by receiving plural work units from a central data processing node, where the central data processing node partitions the data set into the plural work units with plural objects and distributes the plural work units to respective ones of multiple data processing nodes. The plural objects in corresponding work units are mapped into respective ones of given sub-indexes. The mapped objects are reduced, where the central data processing node constructs a composite index for the objects in the data set by reducing the mapped objects, and wherein reducing the mapped objects is distributed among multiple data processing nodes.

In another example embodiment described herein, an index for a data set of plural objects is constructed by designating a first pivot object from among a current set of the plural objects and selecting a second pivot object most distant from the first pivot object from among the current set of the plural objects. Each object in the current set, other than the first and second pivot objects, is projected onto a one-dimensional subspace defined by the first and second pivot objects. The projected objects are partitioned into no more than M subsections of the one-dimensional subspace, wherein M is greater than or equal to 2. For each subsection, it is determined whether all of the projected objects in such subsection do or do not lie within a predesignated threshold of each other. For each subsection, responsive to a determination that all of the projected objects in such subsection lie within the predesignated threshold of each other, a child leaf is constructed in the index which contains a list of each object in the subsection and which further contains the first and second pivot objects and a numerical value indicative of position of the projection onto the one-dimensional subspace. For each subsection, responsive to a determination that all of the projected objects in such subsection do not lie within the predesignated threshold of each other, a child node is constructed in the index by recursive application of the aforementioned steps of designating, selecting, projecting and determining, where the aforementioned steps are applied to a reduced current set of objects which comprise the objects in such subsection, and where the child node contains the first and second pivot objects and further contains a numerical value indicative of position of the projection of the object farthest from the first pivot object.

By virtue of distributing the partitioned data set to multiple data processing nodes for mapping and reducing, it is typically possible to decrease the computing resources used by a processing node to construct and search an index, as well as to decrease processing time. Further, when the entire data-set is too big to be processed by a single node due to insufficient resource (for example when there is. not enough memory to load the data), by breaking up the data-set into smaller chunks (where the sub-set can fit in memory), each node can process a sub-set more efficiently. Additionally, it is ordinarily possible to provide a framework which can create different types of indexes. For example, a framework can be provided which creates a hierarchical index such as a Hierarchical K Means (HK means) index, a Hierarchical FastMap (HFM), as well as a flat index such as a Locality-Sensitive Hashing (LSH) index.

According to some example embodiments described herein, a first pivot object is selected randomly. According to one example embodiment described herein, the one-dimensional subspace is in a direction of large variation between the first and second pivot objects. According to some example embodiments, distance is calculated based on a distance metric over a metric space. According to one example embodiment, partitioning comprises partitioning into M subsections of approximately equal size. In other example embodiments, partitioning comprises one-dimensional clustering into M naturally-occurring clusters.

In some example embodiments, steps of designating, selecting, projecting and determining are recursively applied to sequentially reduced sets of objects until a determination that all of the projected objects in each subsection of the reduced set of objects lie within the predesignated threshold of each other.

According to some example embodiments, K nearest neighbors of a query object are retrieved from a data set of plural objects, by accessing an index for the data set of plural objects, the index comprising child nodes and child leaves which each may contain first and second pivot objects and a numerical value. A child node is selected from a list of nodes. The query object is projected onto a one-dimensional subspace defined by the first and second pivot objects of the child node. The projected query object is categorized into one of M subsections of the one-dimensional subspace, where M is greater than or equal to 2, by comparison of the projected query object and the numerical value contained in the child node. It is determined whether the number of objects contained in the categorized subsection and all sub-nodes thereof is or is not K or less. Responsive to a determination that the number of objects contained in the categorized subsection and all sub-nodes thereof is K or less, the objects contained in the categorized subsection and all sub-nodes thereof are retrieved and such objects are inserted into a list of the K nearest neighbors to the query object. Responsive to a determination that the number of objects contained in the categorized subsection and all sub-nodes thereof is not K or less the child node is added to the list of nodes wherein the child node selection is ordered by a the minimum distance of the query object to any potential object in the subsection, and the aforementioned steps of selecting, projecting, categorizing and determining are repeatedly applied.

In some of these example embodiments, the steps of selecting, projecting, categorizing and determining are repeatedly applied until there are no more nodes to select that can contain objects closer than the current knowledge of the K nearest. In other example embodiments, the steps of selecting, projecting, categorizing and determining are repeatedly applied until a certain number of nodes has been visited, a certain number of leaves have been examined, a certain amount of time has passed, and/or the frequency of finding objects closer than those in the current list of the top K is below some pre-specified threshold. In some of these example embodiments, the steps of selecting, projecting, categorizing and determining may be recursively applied to sequential updates of the child node until a determination that the number of objects contained in the categorized subsection and all sub-nodes thereof is K or less.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a view for explaining an example environment in which aspects of the present disclosure may be practiced.

FIG. 2 is a block diagram for explaining an example internal architecture of the central data processing node shown in FIG. 1 according to one example embodiment.

FIG. 3 is a block diagram for explaining an example internal architecture of a slave data processing node shown in FIG. 1 according to one example embodiment.

FIG. 4A is a representational view for explaining a tree structure based on a HK means algorithm or a HFM algorithm according to one example embodiment.

FIG. 4B is a representational view for explaining a sub-tree in a tree structure based on a HK means algorithm or a HFM algorithm according to one example embodiment.

FIG. 5A is a representational view for explaining an unbalanced tree structure based on a HK means algorithm according to one example embodiment.

FIG. 5B is a representational view for explaining a balanced tree structure based on a HK means algorithm according to one example embodiment.

FIG. 6A is a representational view for explaining a distributed index based on Locality-Sensitive Hashing (LSH) according to one example embodiment.

FIG. 6B is a representational view for explaining a distributed index based on a HK means algorithm or a HFM algorithm according to one example embodiment.

FIG. 7 is a representational view for explaining construction of a distributed index according to an example embodiment.

FIG. 8 is a representational view for explaining construction of a distributed index according to an example embodiment based on a HK means algorithm or a HFM algorithm.

FIG. 9 is a representational view for explaining an updating post-process according to an example embodiment.

FIG. 10A is a representational view for explaining a rebalancing post process according to one example embodiment.

FIG. 10B is a representational view for explaining a rebalancing post process according to one example embodiment.

FIG. 11 is a flowchart for explaining processing in a central data processing node according to an example embodiment.

FIG. 12 is a flowchart for explaining processing in a slave data processing node according to an example embodiment.

FIGS. 13 to 15 are representational views for explaining partitioning of a tree node according to one example embodiment.

FIG. 16 is a representational view for explaining distributed processing and data flow according to an example embodiment.

FIG. 17 is a flowchart for explaining processing for a K-nearest neighbor search using HFM according to an example embodiment.

FIG. 18 is a flowchart for explaining a HFM tree build process according to an example embodiment.

### DETAILED DESCRIPTION

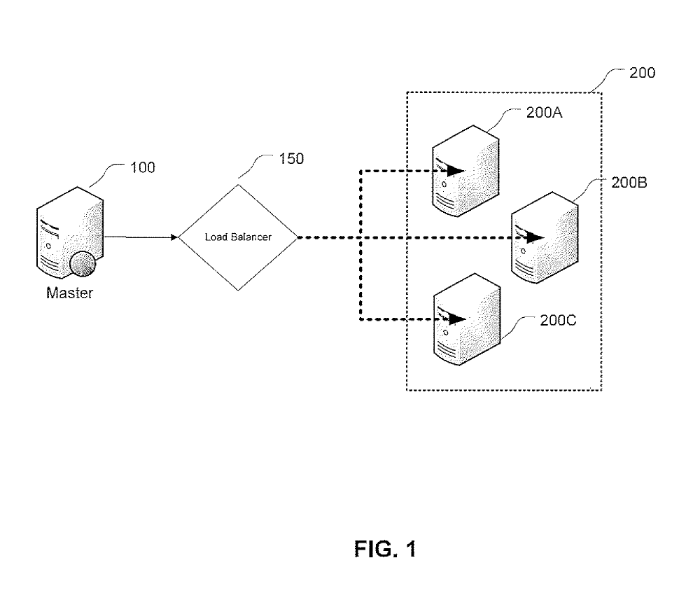

FIG. 1 illustrates an example environment in which aspects of the present disclosure may be practiced. Central data processing node 100 generally comprises a programmable general purpose computer which is programmed as described below so as to perform particular functions and, in effect, become a special purpose computer when performing these functions. Central node 100 may in some embodiments include a display screen, a keyboard for entering text data and user commands, and a pointing device, although such equipment may be omitted. The pointing device preferably comprises a mouse for pointing and for manipulating objects displayed on the display screen.

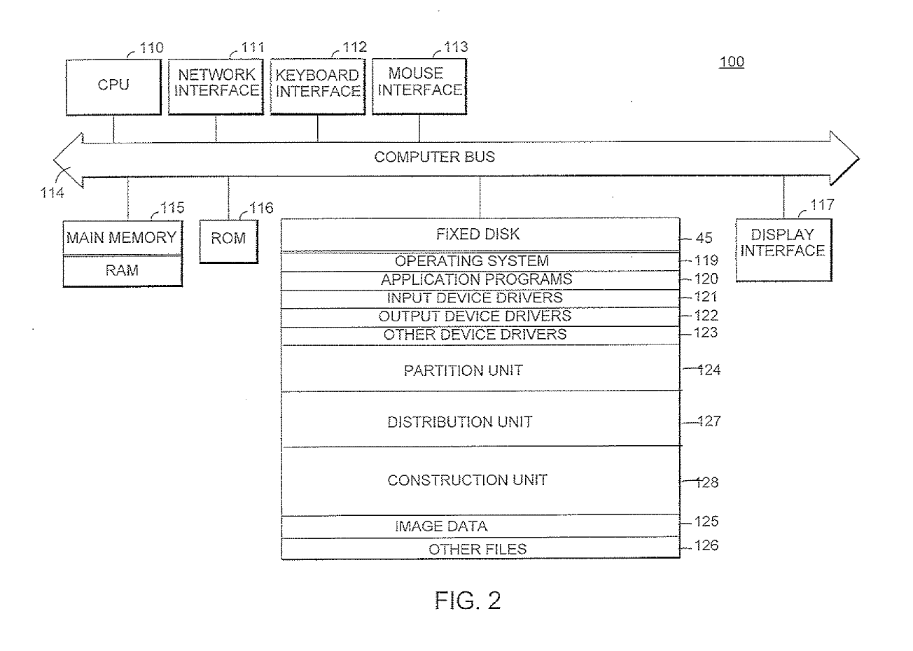

Central node 100 also includes computer-readable memory media, such as fixed disk 45 (shown in FIG. 2), which is constructed to store computer-readable information, such as computer-executable process steps or a computer-executable program for causing central data processing node 100 to construct a composite index, as described below. In some embodiments, central node 100 includes a disk drive (not shown), which provides a means whereby central node 100 can access information, such as image data, computer-executable process steps, application programs, etc., stored on removable memory media. In an alternative, information can also be retrieved through other computer-readable media such as a USB storage device connected to a USB port (not shown), or through a network interface (not shown). Other devices for accessing information stored on removable or remote media may also be provided.

Central node 100 may also acquire image data from other sources, such as output devices including a digital camera and a scanner. Image data may also be acquired through a local area network or the Internet via a network interface.

In the embodiment shown in FIG. 1, there is a single central node 100. In other example embodiments, multiple central nodes similar to central node 100 may be provided.

Multiple slave data processing nodes 200 comprise slave node 200A, slave node 200B and slave node 200C. Each of slave nodes 200A-C comprises a programmable general purpose computer which is programmed as described below so as to perform particular functions and, in effect, become a special purpose computer when performing these functions. Similar to central node 100, each of data processing nodes 200A to C may in some embodiments include a display screen, a keyboard for entering text data and user commands, and a pointing device, although such equipment may be omitted. The pointing device preferably comprises a mouse for pointing and for manipulating objects displayed on the display screen.

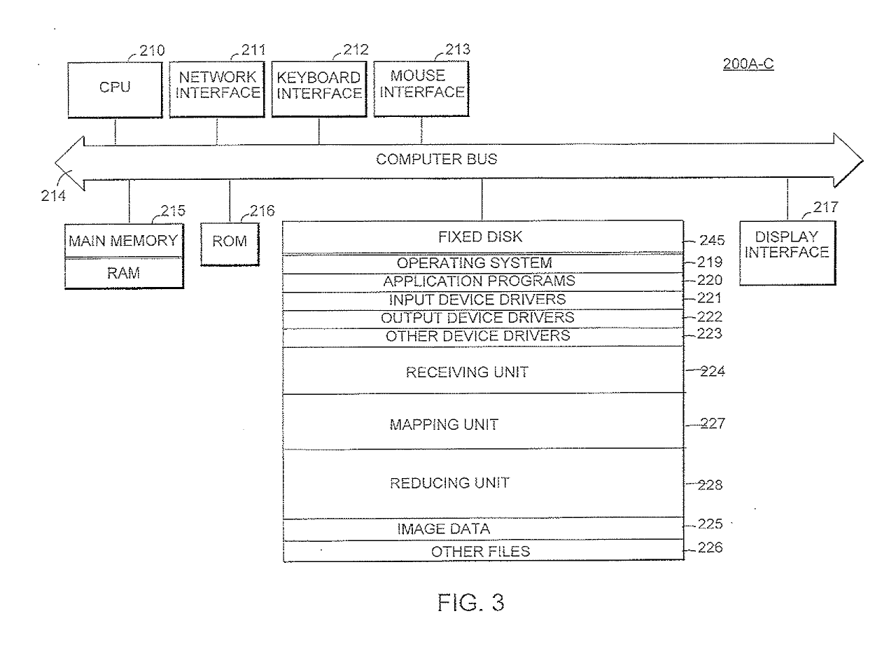

Also similar to central node 100, each of slave nodes 200A to C includes computer-readable memory media, such as fixed disk 245 (shown in FIG. 3), which is constructed to store computer-readable information, such as computer-executable process steps or a computer-executable program for causing each of slave nodes 200A to C to map and reduce data objects, as described below. In some embodiments, each of slave nodes 200A to C includes a disk drive (not shown), which provides a means whereby each of slave nodes 200A to C can access information, such as image data, computer-executable process steps, application programs, etc., stored on removable memory media. In an alternative, information can also be retrieved through other computer-readable media such as a USB storage device connected to a USB port (not shown), or through a network interface (not shown). Other devices for accessing information stored on removable or remote media may also be provided.

Each of slave nodes 200A to C may also acquire image data from other sources, such as output devices including a digital camera and a scanner. Image data may also be acquired through a local area network or the Internet via a network interface.

In the embodiment shown in FIG. 1, slave nodes 200 comprise slave nodes 200A to C merely for the sake of simplicity. It should be understood that slave nodes 200 can include any number of slave nodes N.

Load balancer 150 balances the load between central node 100 and slave nodes 200A to C, which communicate with one another over network interfaces. The main responsibility of the “Load Balancer” is to distribute work evenly while taking data locality into account. The actual load balancing is handled by the distributed processing framework. For example, the Apache Hadoop framework may be used to act as a distributed processing framework. The “Work Units” can optionally provide data locality information. For example, the Hadoop framework is configured to execute a predefined number of “Mapping Units” per slave node. Hadoop will assign a “Work Unit” to an idle “Mapping Unit”. In addition Hadoop takes into consideration the locality of input data that is contained/addressed by the “Work Unit”. In the case where the “Work Unit” contains data that locally resides on a particular slave node, the “Work Unit” will be assigned to a “Mapping Unit” that is bounded to that node.

While FIG. 1 depicts a central data processing node and multiple slave data processing nodes, computing equipment for practicing aspects of the present disclosure can be implemented in a variety of embodiments.

FIG. 2 is a block diagram for explaining an example internal architecture of the central data processing node shown in FIG. 1. As shown in FIG. 2, central node 100 includes central processing unit (CPU) 110 which may be a multi-core CPU and which interfaces with computer bus 114. Also interfacing with computer bus 114 are fixed disk 45 (e.g., a hard disk or other nonvolatile computer-readable storage medium), network interface 111 for accessing other devices across a network, keyboard interface 112 for a keyboard, mouse interface 113 for a pointing device, random access memory (RAM) 115 for use as a main run-time transient memory, read only memory (ROM) 116, and display interface 117 for a display screen or other output.

RAM 115 interfaces with computer bus 114 so as to provide information stored in RAM 115 to CPU 110 during execution of the instructions in software programs, such as an operating system, application programs, data processing modules, and device drivers. More specifically, CPU 110 first loads computer-executable process steps from fixed disk 45, or another storage device into a region of RAM 115. CPU 110 can then execute the stored process steps from RAM 115 in order to execute the loaded computer-executable process steps. Data, such as image data 125, index data, and other information, can be stored in RAM 115 so that the data can be accessed by CPU 110 during the execution of the computer-executable software programs, to the extent that such software programs have a need to access and/or modify the data.

As also shown in FIG. 2, fixed disk 45 contains computer-executable process steps for operating system 119, and application programs 120, such as image management programs. Fixed disk 45 also contains computer-executable process steps for device drivers for software interface to devices, such as input device drivers 121, output device drivers 122, and other device drivers 123.

Image data 125 is available for data processing, as described below. Other files 126 are available for output to output devices and for manipulation by application programs.

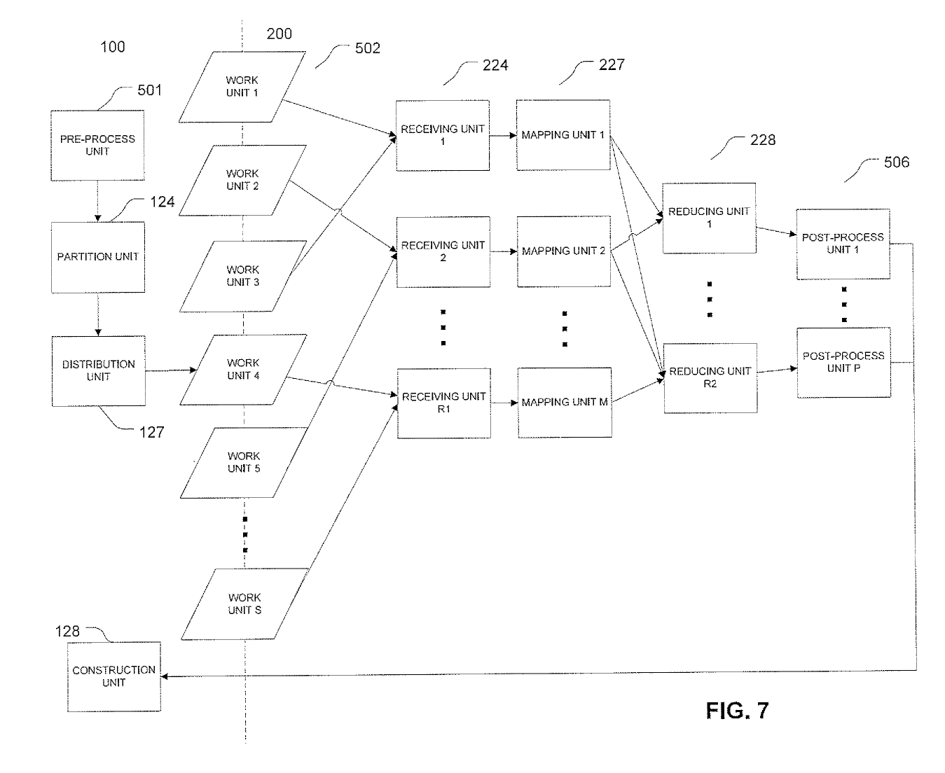

Partition unit 124 comprises computer-executable process steps stored on a computer-readable storage medium such as disk 45. Partition unit 124 is constructed to partition a data set of objects into plural work units each with plural objects. The operation of partition unit 124 is discussed in more detail below with respect to FIG. 7.

Distribution unit 127 comprises computer-executable process steps stored on a computer-readable storage medium such as disk 45. Distribution unit 127 is constructed to distribute the plural work units to respective ones of multiple data processing nodes 200, which map the plural objects in corresponding work units into respective ones of given sub-indexes. The operation of distribution unit 127 is discussed in more detail below with respect to FIG. 7.

Construction unit 128 comprises computer-executable process steps stored on a computer-readable storage medium such as disk 45. Construction unit 128 is constructed to construct a composite index for the objects in the data set by reducing the mapped objects. More specifically, and according to one example embodiment, reducing the mapped objects is distributed among multiple data processing nodes 200. According to some example embodiments, construction unit 128 is constructed to generate different types of composite indexes. For example, in one embodiment, construction unit 128 constructs a hierarchical index such as a HK Means index. In another embodiment, construction unit 128 constructs a flat index such as a Locality-Sensitive Hashing (LSH) index. In yet another embodiment, construction unit 128 constructs a hierarchical index such as a HFM index. The operation of construction unit 128 is discussed in more detail below with respect to FIG. 7.

The computer-executable process steps for partition unit 124, distribution unit 127 and construction unit 128 may be configured as part of operating system 119, as part of an output device driver, such as a processing driver, or as a stand-alone application program. These units may also be configured as a plug-in or dynamic link library (DLL) to the operating system, device driver or application program. It can be appreciated that the present disclosure is not limited to these embodiments and that the disclosed units may be used in other environments.

In this example embodiment, partition unit 124, distribution unit 127 and construction unit 128 are stored on fixed disk 45 and executed by CPU 110. Of course, other hardware embodiments outside of a CPU are possible, including an integrated circuit (IC) or other hardware, such as DIGIC units, or GPU.

FIG. 3 is a block diagram for explaining an example internal architecture of a slave data processing node shown in FIG. 1. As shown in FIG. 3, each of slave nodes 200A-C includes at least one central processing unit (CPU) 210 which may be a multi-core CPU and which interfaces with computer bus 214. Also interfacing with computer bus 214 are fixed disk 245 (e.g., a hard disk or other nonvolatile computer-readable storage medium), network interface 211 for accessing other devices across a network, keyboard interface 212 for a keyboard, mouse interface 213 for a pointing device, random access memory (RAM) 215 for use as a main run-time transient memory, read only memory (ROM) 216, and display interface 217 for a display screen or other output.

RAM 215 interfaces with computer bus 214 so as to provide information stored in RAM 215 to CPU 210 during execution of the instructions in software programs, such as an operating system, application programs, image processing modules, and device drivers. More specifically, CPU 210 first loads computer-executable process steps from fixed disk 245, or another storage device into a region of RAM 215. CPU 210 can then execute the stored process steps from RAM 215 in order to execute the loaded computer-executable process steps. Data, such as image data 225, index data, and other information, can be stored in RAM 215 so that the data can be accessed by CPU 110 during the execution of the computer-executable software programs, to the extent that such software programs have a need to access and/or modify the data.

As also shown in FIG. 3, fixed disk 245 contains computer-executable process steps for operating system 219, and application programs 220, such as image management programs. Fixed disk 245 also contains computer-executable process steps for device drivers for software interface to devices, such as input device drivers 221, output device drivers 222, and other device drivers 223.

Image data 225 is available for data processing, as described below. Other files 226 are available for output to output devices and for manipulation by application programs.

Receiving unit 224 comprises computer-executable process steps stored on a computer-readable storage medium such as disk 245. Receiving unit 224 is constructed to receive plural work units from a central data processing node 100. The operation of receiving unit 224 is discussed in more detail below with respect to FIG. 7.

Mapping unit 227 comprises computer-executable process steps stored on a computer-readable storage medium such as disk 245. Mapping unit 227 is constructed to map the plural objects in corresponding work units into respective ones of given sub-indexes. The operation of mapping unit 227 is discussed in more detail below with respect to FIG. 7.

Reducing unit 228 comprises computer-executable process steps stored on a computer-readable storage medium such as disk 245. Reducing unit 228 is constructed to reduce the mapped objects. The central data processing node 100 may construct a composite index for the objects in the data set from the reduced objects. The operation of reducing unit 228 is discussed in more detail below with respect to FIG. 7.

The computer-executable process steps for receiving unit 224, mapping unit 227 and reducing unit 228 may be configured as part of operating system 219, as part of an output device driver, such as a processing driver, or as a stand-alone application program. These units may also be configured as a plug-in or dynamic link library (DLL) to the operating system, device driver or application program. It can be appreciated that the present disclosure is not limited to these embodiments and that the disclosed units may be used in other environments.

In this example embodiment, receiving unit 224, mapping unit 227 and reducing unit 228 are stored on fixed disk 245 and executed by CPU 210. Of course, other hardware embodiments outside of a CPU are possible, including an integrated circuit (IC) or other hardware, such as DIGIC units or GPU.

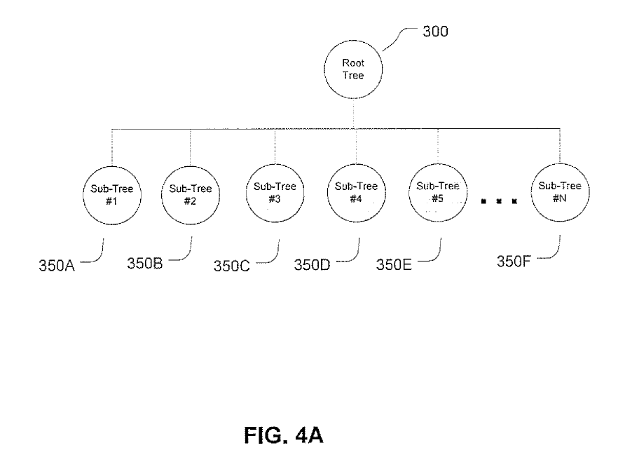

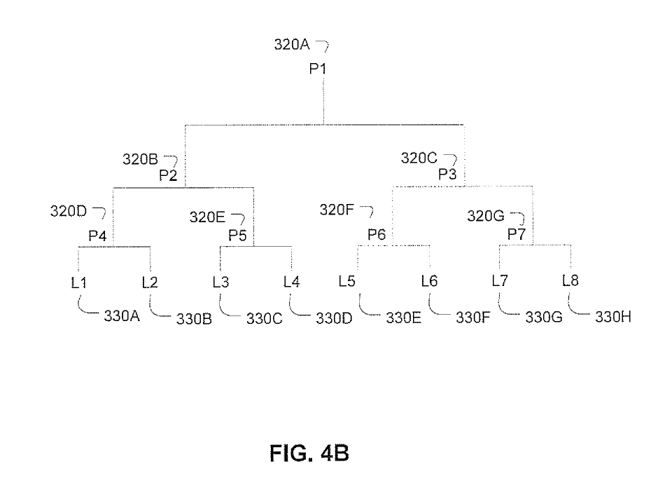

FIG. 4A is a representational view for explaining a tree structure based on a HK Means algorithm or a HFM algorithm which clusters similar objects into data clusters that are organized based on the tree structure. The tree structure represents an index for the data objects. In this embodiment, the data objects are image data. In other embodiments, the data objects represent text, text mixed with image data, a DNA sequence, audio data, or other types of data to be indexed. As shown in FIG. 4A, the tree structure includes root tree 300 and N sub-trees 350A to F.

According to this example embodiment, the tree structure is composed of parent nodes, sub-tree nodes and leaf nodes. A leaf node represents a data object such as image data or a reference to an image included in a data set. A parent node represents a cluster centroid that contains a list of child nodes. In some embodiments, a parent node also includes statistical information such as a maximum distance representing the radius of a data cluster and an object count representing a total number of child leaves. In other embodiments the parent node may contain the statistics necessary to determine to which child tree an object should be assigned. A sub-tree node is similar to a parent node, except instead of including a list of child nodes, a sub-tree node includes pointers or identifiers to a separate tree. Accordingly, the entire HK Means or HFM tree structure can be partitioned into separate tree structures that can be generated and searched separately in a distributed manner.

FIG. 4B is a representational view for explaining a sub-tree included in the tree structure of FIG. 4A. As shown in FIG. 4B, the sub-tree includes parent nodes 320A to G and leaf nodes 330A to H.

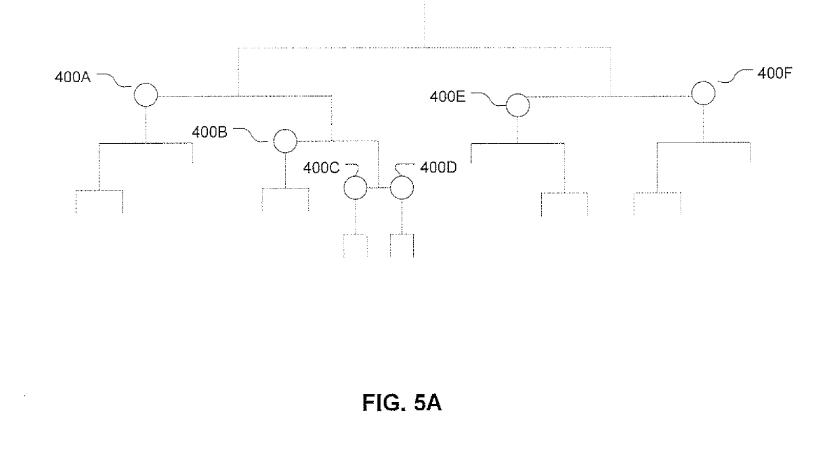

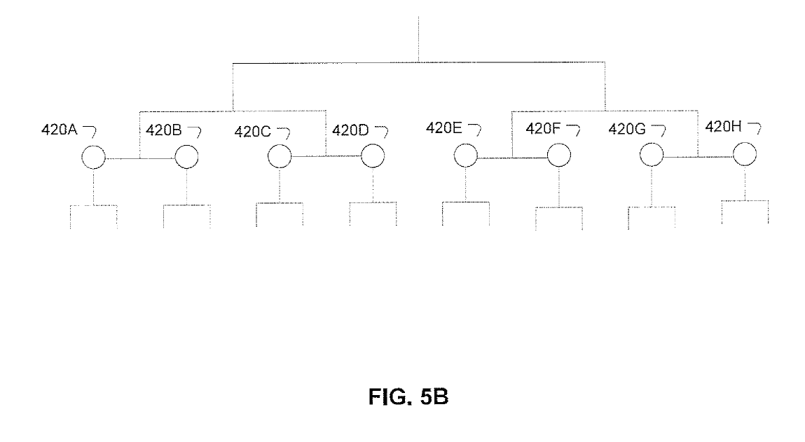

FIG. 5A is a representational view for explaining an unbalanced tree structure based on a HK Means algorithm. More specifically, when constructing the tree, cluster centroids are selected in order to facilitate organization of the data objects. The centroids can be selected at the same level or at different levels based on the balancing of the tree structure. In order to divide the entire HK based tree evenly; sub-tree centroids 400A to F have to be chosen in such a way that each referenced sub-tree contains roughly the same number of parent/leaf nodes. In a balanced tree this can be accomplished by choosing cluster centroids 420A to H at a given tree level as shown in FIG. 5B. In an unbalanced tree as shown in FIG. 5A nodes are chosen is such a manner that each resulting sub-trees contains roughly the same number of parent/leaf nodes. FIG. 5A depicts an example embodiment in which cluster centroids 400A to F are selected in an unbalanced HK Means tree structure. On the other hand, FIG. 5B depicts an example embodiment in which cluster centroids 420A to H are selected in a balanced HK Means tree structure.

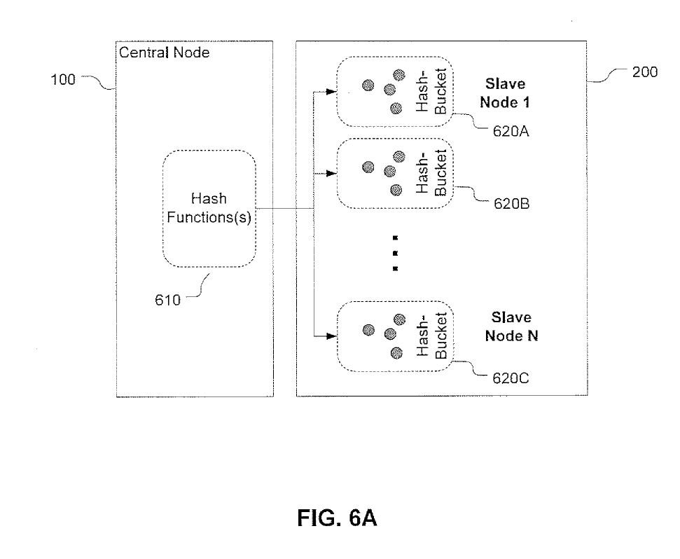

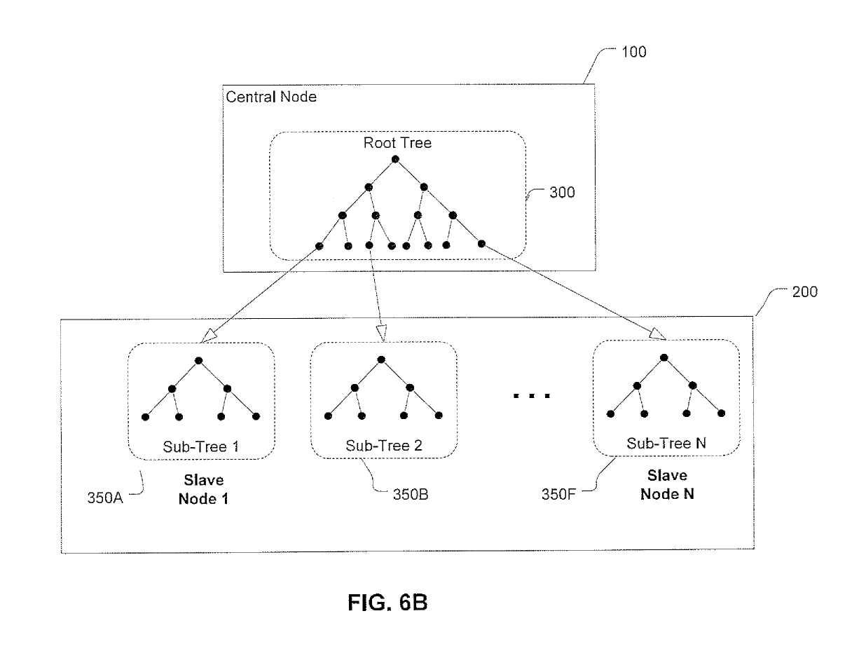

FIG. 6A is a representational view for explaining a distributed index based on Locality-Sensitive Hashing (LSH). LSH is a method of performing probabilistic dimension reduction of high-dimensional data. Typically, LSH methods use one or more hash functions 610 that assign a data object to a bucket 620A to C or sub-index, such that similar objects are mapped to the same bucket or sub-index with high probability. Thus, an index for performing a K Nearest Neighbor (KNN) search can be generated based on an LSH algorithm.

According to this example embodiment, in which an index is generated based on an LSH algorithm, one or more hash functions are stored at central node 100 while the plurality of buckets or sub-indexes are stored at slave nodes 200 such as slave nodes 200A to C (as shown in FIG. 1), such that the LSH index is distributed. The distributed LSH index can then be searched in a distributed manner.

In the embodiment of FIG. 6A, one hash function is stored at central node 100. In other example embodiments, multiple hash functions may be stored at the central node 100. In still other example embodiments, one or more hash functions may also be stored at the slave nodes, such that the hash functions are executed in parallel.

FIG. 6B is a representational view for explaining a distributed index based on a HK Means (or the HFM) algorithm. According to this example embodiment, a root tree, such as root tree 300, is stored at central node 100, and sub-trees 1 to N, such as sub-trees 350A to F, are stored in slave nodes 1 to N, respectively, such that the HK Means (or HFM) index is distributed. The distributed HK Means (or HFM) index can then be searched in a distributed manner.

The distributed indexes shown in FIGS. 6A and 6B can be accessed in order to perform a search. In particular, in one example embodiment, a node such as nodes 100 and 200 includes an accessing unit constructed to access a composite index, such as the indexes shown in FIGS. 6A and 6B. A reception unit is constructed to receive a query object such as a query image, and a searching unit is constructed to search the composite index to retrieve K most similar objects (i.e., images) to the query image. Thus, searching of the composite index is distributed among multiple nodes, and can be executed in parallel.

More specifically, in order to identify sub-tree candidates for a search, a central node analyzes the root tree. The central node then distributes tasks to data processing nodes having the identified sub-tree candidates, instructing each of these nodes to search their particular sub-tree. Once the sub-trees have been searched, each result is communicated from the data processing node to the central node. The central node merges the results in order to determine a final search result.

FIG. 7 is a representational view for explaining the construction of a distributed index, such as the indices shown in FIGS. 6A and 6B. According to some example embodiments, a framework such as Apache Hadoop is used to coordinate the execution of the units and the exchange of the data shown in FIG. 7. Of course, another suitable framework can be used in other embodiments.

FIG. 7 depicts central data processing node 100 and slave nodes 200 for indexing a data set of objects. In this example embodiment, the objects to be indexed are image data. In other example embodiments, the objects can represent text, text mixed with image data, a DNA sequence, or other types of data to be indexed.

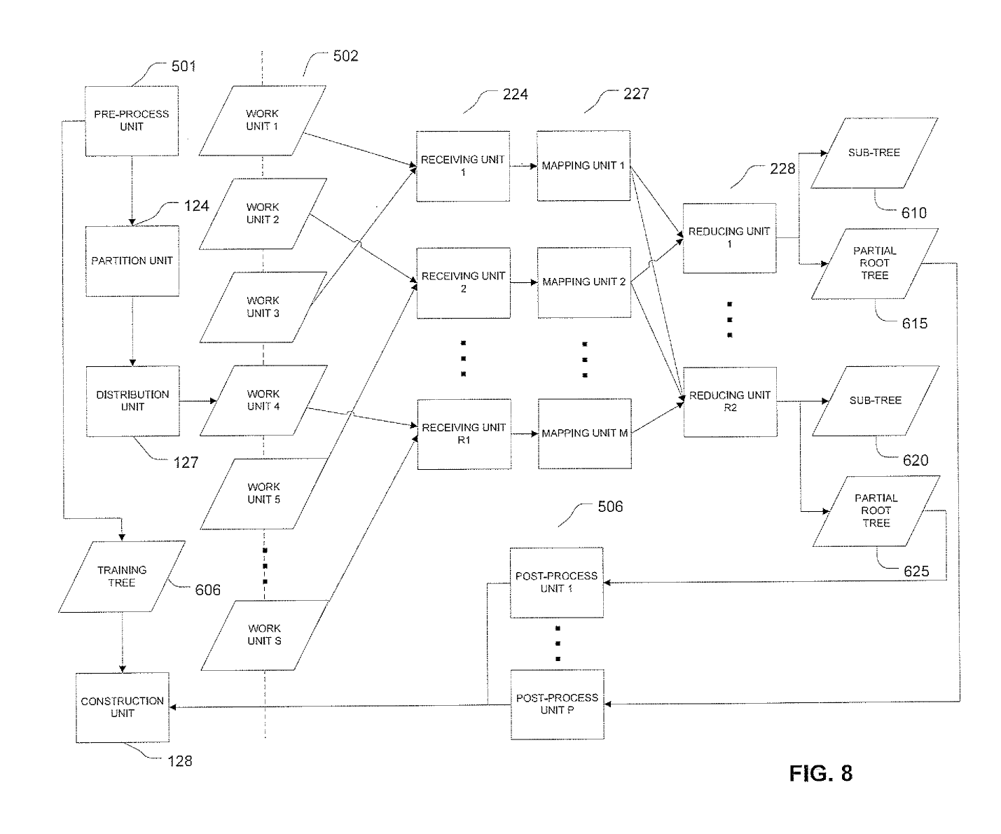

In the embodiment of FIG. 7, the central data processing node 100 includes pre-process unit 501, partition unit 124, distribution unit 127 and construction unit 128. Pre-process unit 501 is constructed to generate a training tree by performing a HK means algorithm on a sample of the data set in a pre-process phase. In another embodiment the HFM algorithm is used in the pre-process phase. The operation of pre-process unit 501 is discussed in detail in connection with FIG. 8. In yet another example embodiment, pre-process unit 501 is constructed to define a hash function in the pre-process phase. The hash function is used to map an object to a particular bucket or sub-index.

Partition unit 124 partitions the data set into plural work units 502 each with plural objects. In some example embodiments, each of the plural work units has approximately the same number of plural objects. Distribution unit 127 distributes the plural work units 502 to respective ones of multiple data processing nodes 200, and each data processing node maps the plural objects in corresponding work units into respective ones of given sub-indexes. Construction unit 128 constructs a composite index for the objects in the data set by reducing the mapped objects. As discussed in more detail below, reducing the mapped objects may be distributed among multiple data processing nodes.

In some example embodiments, central node 100 also includes a feature unit constructed to derive at least one feature vector for each object in the data set, and the composite index comprises an index based on the one or more feature vector.

In the embodiment of FIG. 7, slave nodes 200 include receiving units 224 1 to R1, mapping units 227 1 to M, reducing units 228 1 to R2 and post-process units 506 1 to P. More specifically, according to this example embodiment, slave node 200A includes receiving unit 224 1, mapping unit 227 1, reducing unit 228 1 and post-process unit 506 1, slave node 200B includes receiving unit 224 2, mapping unit 227 2, reducing unit 228 2 and post-process unit 506 2, and slave node 200C includes receiving unit 224 3, mapping unit 227 3, reducing unit 228 3 and post-process unit 506 3. In other embodiments each of slave nodes 200A to C can include one or more of any of receiving units 224 1 to R1, mapping units 227 1 to M, reducing units 228 1 to R2 and post-process units 506 1 to P.

As shown in FIG. 7, receiving units 224 1 to R1 each receive plural work units 502 from central data processing node 100. Mapping units 227 1 to M each respectively map the plural objects 502 into respective ones of given sub-indexes. Each of mapping units 227 1 to M outputs an object ID which identifies an object of the data set and optionally object data such as image features extracted from a given image. This way the reducing unit 228 doesn't need to look up the object data during the sub-index construction. The object ID, optional feature data and sub-index ID are provided to reducing units 228 1 to R2, so that reducing units 228 1 to R2 can respectively reduce all of the objects mapped to a particular sub-index.

Each reducing unit 228 reduces all of the objects that are mapped to the sub-index being processed by the respective reducing unit 228, such that reducing the mapped objects is distributed among multiple data processing nodes 200. In one example embodiment, the data processing nodes 200 reduce the mapped objects by performing a HK means algorithm on the mapped objects. In another embodiment, the data processing nodes 200 reduce the mapped objects by performing a HFM algorithm on the mapped objects. These embodiments are explained in more detail below in connection with FIG. 8. In other example embodiments, the data processing nodes 200 reduce a mapped object by assigning the mapped objects to a bucket. In particular, when all of the objects have been mapped to a particular LSH bucket, the mapped data is reduced by serializing all of the objects assigned to the bucket.

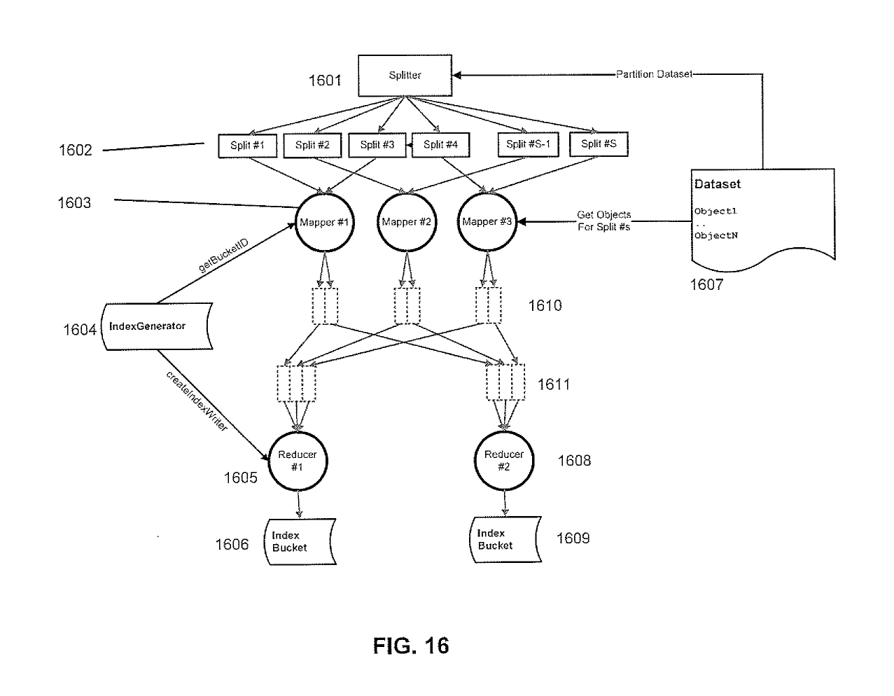

In some example embodiments in which a data processing node does not have the appropriate reducing unit to reduce a mapped object, at least a first one of the multiple data processing nodes 200 receives the mapped data objects from at least a second one of the multiple data processing nodes 200, and the mapped data objects are reduced by the data processing nodes that receive the mapped objects. More specifically, in such embodiments, each of the data processing nodes 200 may include a second receiving unit constructed to receive the mapped data objects from the other data processing nodes, and the received mapped data objects are reduced by the appropriate reducing unit. In this example embodiment, the Hadoop framework is used in order to facilitate the exchange of data between the data processing nodes 200, such that the processing is distributed. This is particularly advantageous in a case where a particular data processing node does not locally include the appropriate reducing unit for reducing objects which are mapped to a particular sub-index, since the mapped data is remotely reduced by another data processing node. Mapped data exchange will be described later by using FIG. 16.

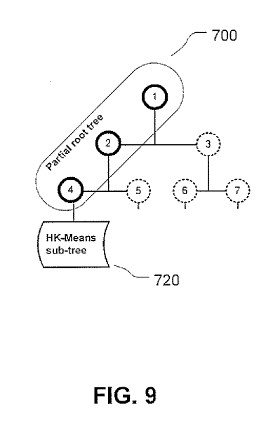

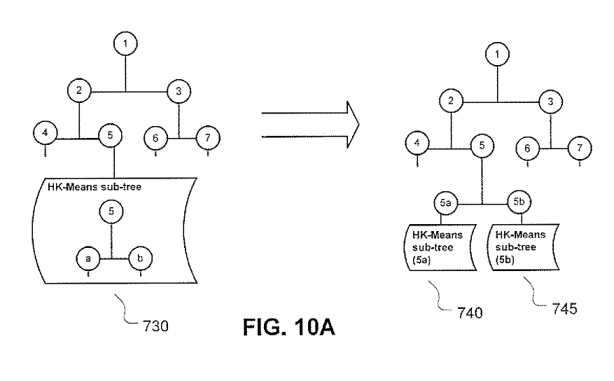

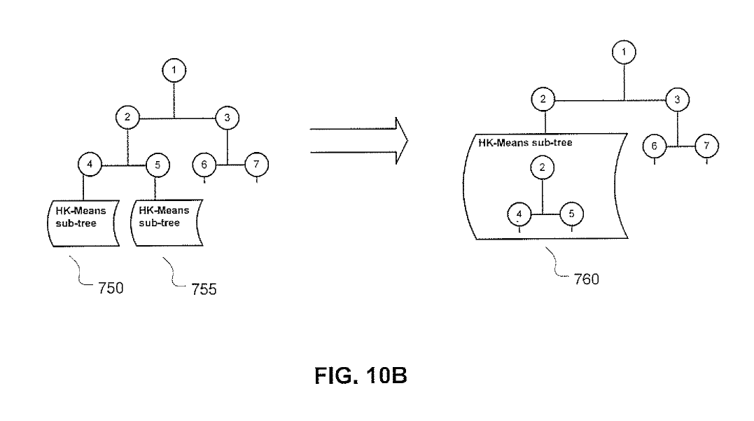

In some example embodiments, data processing nodes 200 include post-process units 506 1 to P constructed to provide updated statistics for updating the composite index. In such embodiments, the construction unit 128 of the central node 100 updates the composite index based on updated statistics provided by the multiple data processing nodes 200. In other example embodiments, post process units 506 1 to P are constructed to provide rebalancing information for rebalancing the composite index. In these embodiments, the construction unit 128 of the central node 100 rebalances the composite index based on such information. These post-processes 506 are explained in more detail in connection with FIGS. 9 and 10.

FIG. 8 is a representational view for explaining construction of a distributed HK Means index or the HFM index, such as the index shown in FIG. 6B. In these example embodiments, the objects to be indexed are image data. In other example embodiments, the objects can represent text, text mixed with image data, a DNA sequence, audio data, or other types of data to be indexed. Units shown in FIG. 8 that are similar to units shown in FIG. 7 are similarly labeled. For the sake of brevity, a detailed description of such units will be omitted here.

In the embodiment of FIG. 8, slave nodes 200 include receiving units 224 1 to R1, mapping units 227 1 to M, reducing units 228 1 to R2 and post-process units 506 1 to P. More specifically, according to this example embodiment, slave node 200A includes receiving unit 224 1, mapping unit 227 1, reducing unit 228 1 and post-process unit 506 1, slave node 200B includes receiving unit 224 2, mapping unit 227 2, reducing unit 228 2 and post-process unit 506 2, and slave node 200C includes receiving unit 224 3, mapping unit 227 3, reducing unit 228 3 and post-process unit 506 3. In other embodiments each of slave nodes 200A to C can include one or more of any of receiving units 224 1 to R1, mapping units 227 1 to M, reducing units 228 1 to R2 and post-process units 506 1 to P.

As shown in FIG. 8, a central node for constructing a composite index includes a pre-process unit 501. According to this example embodiment, pre-process unit 501 is constructed to generate a training tree 606 by performing a HK means algorithm on a sample of the data set in a pre-process phase. In other example embodiments, pre-process unit 501 is constructed to generate a training tree 606 by performing a HFM algorithm on the data set in the pre-process phase.

According to this example embodiment, the sample data set is obtained by randomly selecting a number of objects from the data set and performing a HK Means algorithm to cluster the selected objects. Of course, the sample set can be obtained by any other suitable means. The training tree 606 is used to further organize the objects in the data set into a tree structure. In particular, as shown in FIG. 8, training tree 606 is provided to construction unit 128 in order to construct the HK means index in this example embodiment. In other example embodiments, a training tree that is generated by performing a HFM algorithm is provided to construction unit 128 in order to construct a HFM index. In some embodiments, training tree 606 is distributed to the multiple data processing nodes in order to facilitate construction of the composite index.

In order to generate training tree 606 according to the this example embodiment in which a HK means algorithm is used, pre-process unit 501 identifies cluster centroids, such as the centroids represented by the nodes in the trees shown in FIGS. 5A and B. In this example embodiment, each sub-tree is represented by a cluster centroid and an identifier that is used to map a data object to a specific sub-tree. Similar to FIG. 7, mapping units 227 1 to M each map the sample objects into respective sub-trees.

In this example embodiment, the data processing nodes include reducing units 228 1 to R2 that reduce the mapped objects by performing a HK means algorithm on the mapped objects. More specifically, when all of the data set objects have been mapped to a particular sub-tree, each of reducing units 228 1 to R2 reduces all the dataset objects that have been assigned to the particular sub-tree being processed by the reducing unit 228. This results in sub-trees 610 and 620, and partial root trees 615 and 625. With respect to embodiments that involve distributing the training tree 606 to the multiple data processing nodes, each of the multiple data processing nodes also updates its copy of training tree 606 based on sub-trees 610 and 620 and partial root trees 615 and 625, in order to reflect the current statistical information of the tree structure, such as maximum distance and object count.

In order to generate training tree 606 according to other example embodiments in which a HFM algorithm is used, pre-process unit 501 identifies cluster statistics (such as those necessary to determine sub-partitions) represented by the nodes in the trees shown in FIGS. 5A and 5B. In this example embodiment, each sub-tree is represented by a partition and an identifier that is used to map a data object to a specific sub-tree. Similar to FIG. 7, mapping units 227 1 to M each map the sample objects into respective sub-trees.

In this example embodiment, the data processing nodes include reducing units 228 1 to R2 that reduce the mapped objects by performing a HFM algorithm on the mapped objects. More specifically, when all of the data set objects have been mapped to a particular sub-tree, each of reducing units 228 1 to R2 reduces all the dataset objects that have been assigned the particular sub-tree being processed by the reducing unit. This results in sub-trees 610 and 620, and partial root trees 615 and 625. With respect to embodiments that involve distributing the training tree 606 to the multiple data processing nodes, each of the multiple data processing nodes also updates its copy of training tree 606 based on sub-trees 610 and 620 and partial root trees 615 and 625, in order to reflect the current statistical information of the tree structure, such as maximum distance and object count for example. In some example embodiments, partial root trees 615 and 625 are provided to post process units 506 1 to P, so that post-process units 506 1 to P provide updated statistics to the central node for updating the composite index.

FIG. 9 illustrates an example of this update post-process, and depicts a partial root tree 700 that is generated during construction of a sub-tree 720. According to this embodiment, partial root tree 700 includes statistical information for parent nodes of the particular sub-tree. Based on the characteristics of all of the leaf nodes in sub-tree 720, each of parent nodes 1, 2 and 4 is updated by updating its statistical information such as the maximum distance representing the radius of the data cluster (i.e., the distance of leaf node which is furthest from the cluster centroid) and the object count representing the total number of child leaves. In order to construct a final composite index, the central node aggregates the updated statistics from the partial root trees to update the composite index.

In other example embodiments, partial root trees 615 and 625 are provided to post process units 506 1 to P, so that post-process units 506 1 to P provide rebalance information to the central node for rebalancing the composite index. In these embodiments, the construction unit 128 of the central node 100 rebalances the composite index based on such information. More specifically, the construction unit 128 rebalances the index by either splitting sub-trees as shown in FIG. 10A, or combining sub-trees as shown in FIG. 10B. In FIG. 10A, sub-tree 730 is split into sub-trees 740 and 745. In FIG. 10B, sub-trees 750 and 755 are combined into sub-tree 760. This is particularly advantageous for embodiments in which the training tree 606 is generated by a random sample of data.

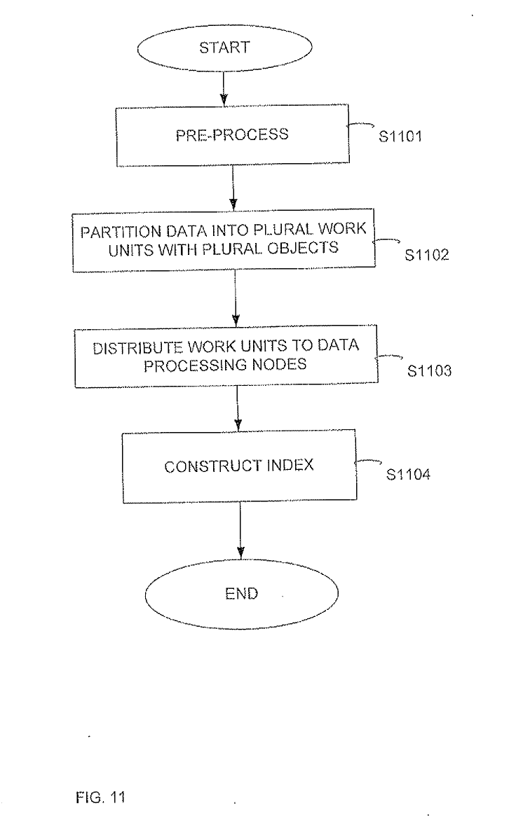

FIG. 11 is a flowchart for explaining processing in a central data processing node that indexes a data set of objects such as image data according to an example embodiment. According to the flowchart of FIG. 11, a pre-process phase is executed in step S1101, in which the central node processes objects in the data set in order to prepare for generation of the index. As discussed above, in one example embodiment, a training tree is constructed in the pre-process phase by performing a HK means algorithm on a sample of the data set. In other embodiments, a hash function is defined in the pre-process phase, where the hash function is used to map data objects to buckets. Yet still in another example embodiment, a training tree is constructed in the pre-process phase by performing the HFM algorithm.

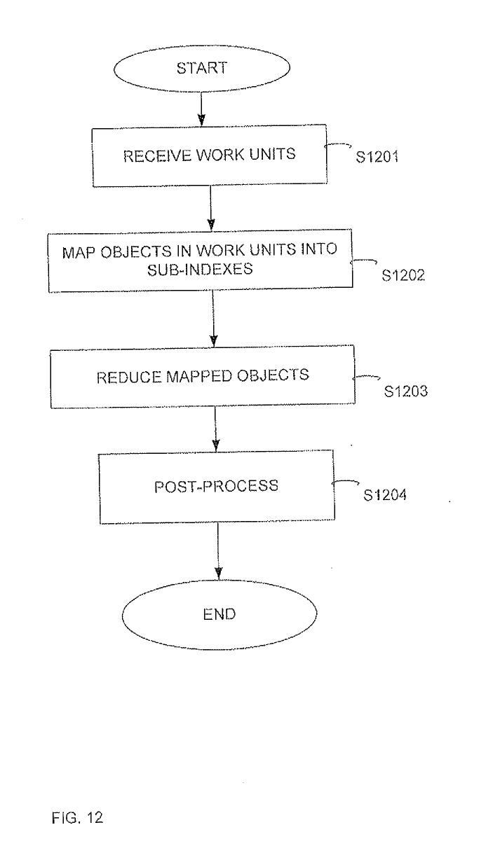

In step S1102, the central node partitions the data set into plural work units each with plural objects. In step S1103, the central node distributes the plural work units to respective ones of multiple data processing nodes. Each data processing node maps the plural objects in corresponding work units into respective ones of given sub-indexes as discussed in connection with FIG. 12.

In step S1104, the central node constructs a composite index for the objects in the data set by reducing the mapped objects, where reducing the mapped objects is distributed among multiple data processing nodes as discussed in connection with FIG. 12. In embodiments that involve receiving updated statistics from the multiple data processing nodes, step S1104 also includes updating the composite index based on the updated statistics. Additionally, in embodiments that involve receiving rebalancing information from the multiple data processing nodes, step S1104 includes rebalancing the composite data.

FIG. 12 is a flowchart for explaining processing in a data processing node that indexes a data set of objects such as image data according to an example embodiment. According to FIG. 12, in step S1201, the data processing node receives plural work units that were distributed by the central node in step S1104 of FIG. 11. In step S1202, the data processing node maps the plural objects in corresponding work units into respective ones of given sub-indexes.

In this embodiment, when all of the objects have been mapped to a particular sub-index, in step S1203, the data processing node reduces the mapped objects, for example, by performing a HK means algorithm or a HFM algorithm on the mapped objects in the sub-index. In some example embodiments in which a data processing node does not have the appropriate reducing unit to reduce a mapped object, at least one of the multiple data processing nodes receives mapped data objects from at least another one of the multiple data processing nodes, so that the data processing node having the appropriate reducing unit reduces the mapped data object. In some embodiments, the reduction of mapped objects S1203 may begin while S1202 is still processing data. For example, sometimes some of the sub-indexes may be determined to be completely mapped or sufficiently mapped (i.e. a large enough sampling of mapped objects), to begin the reduce step even before the all mapping is complete.

In step S1204, the data processing node performs a post-process. In one example embodiment, during the post-process phase, the data processing node provides updated statistics to the central node for updating the composite index in step S1104 of FIG. 11. In some example embodiments, during the post-process phase, the data processing node provides rebalance information to the central node for rebalancing the composite index in step S1104 of FIG. 11.

In an example embodiment in which the HFM algorithm is used, a search tree is built by using the algorithm below. The algorithm creates a hierarchical organization of the objects. It uses Faloutsos and Lin's FastMap algorithm to project the objects into 1-dimension and partitions the space in this dimension. Generally, an index for a data set of plural objects is constructed by creating a node designating a first pivot object from among a current set of the plural objects and selecting a second pivot object most distant from the first pivot object from among the current set of the plural objects. Each object in the current set, other than the first and second pivot objects, is projected onto a one-dimensional subspace defined by the first and second pivot objects. The projected objects are partitioned into no more than M subsections of the one-dimensional subspace, wherein M is greater than or equal to 2. For each subsection, it is determined whether all of the projected objects in such subsection do or do not lie within a predesignated threshold of each other or the number of projected objects is sufficiently small. For each subsection, responsive to a determination that all of the projected objects in such subsection lie within the predesignated threshold of each other or the number of projected objects is sufficiently small, a child leaf node is constructed in the index which contains a list of each object in the subsection and a numerical value indicative of position of the projection onto the one-dimensional subspace. For each subsection, responsive to a determination that all of the projected objects in such subsection do not lie within the predesignated threshold of each other or the number of projected objects is sufficiently small, a child node is constructed in the index by recursive application of the aforementioned steps of designating, selecting, projecting and determining, where the aforementioned steps are applied to a reduced current set of objects which comprise the objects in such subsection, and where the child node contains the first and second pivot objects and further contains a numerical value indicative of position of the projection of the object farthest from the first pivot object.

As discussed in more detail below, according to some example embodiments described herein, a first pivot object is selected randomly. According to one example embodiment described herein, the one-dimensional subspace is in a direction of large variation between the first and second pivot objects. According to some example embodiments, distance is calculated based on a distance metric over a metric space. According to one example embodiment, partitioning comprises partitioning into M subsections of approximately equal size. In other example embodiments, partitioning comprises one-dimensional clustering into M naturally-occurring clusters. In some example embodiments, steps of designating, selecting, projecting and determining are recursively applied to sequentially reduced sets of objects until a determination that all of the projected objects in each subsection of the reduced set of objects lie within the predesignated threshold of each other or the number of projected objects is sufficiently small.

As also discussed in further detail below, a search is performed according to some example embodiments, in which K nearest neighbors of a query object are retrieved from a data set of plural objects. An index for the data set of plural objects is accessed, the index comprising nodes, and child leaf nodes. A node is selected from a prioritized list containing nodes that may be searched. Initially the prioritize list contains the root node which is the top-most node in the tree that is applied to the entire plurality of objects being indexed and which is not a child not to any other nodes. It is determined whether the node is a child leaf node. Responsive to the determination of whether the node is a child leaf node, each object in the child leaf object list are inserted into the K nearest neighbor list in an increasing order according to the distance to the query if either, the K nearest neighbor list has less than K objects, or the distance to the child leaf object from the query object is less than the K-th distance in the K nearest neighbor list. Responsive to the determination that the node is not a child leaf node, the query object is projected onto a one-dimensional subspace defined by the first and second pivot objects of the node. The projected query object is categorized into one of M subsections of the one-dimensional subspace, where M is greater than or equal to 2, by comparison of the projected query object and the numerical value contained in the child node.

The minimum distance of each subsection to the query object is determined and the subsection child nodes are added to the prioritized list of nodes that may be searched where priority is determined based on the minimum distances respectively. It is determined whether a stopping condition has been met. For example, in one example embodiment, the stopping condition is the condition when the prioritized list of nodes that may be searched is empty or the minimum distance to the highest priority node in the list of nodes that may be searched is greater than or equal to the distance of the K-th object in the nearest neighbor list. Responsive to the determination that a stopping condition has not been met, a node is selected from the prioritized list containing nodes that may be searched, and the aforementioned steps of projecting, categorizing and determining to the updated child node are recursively applied.

Also, it may be determined whether the number of objects contained in the categorized subsection and all sub-nodes thereof is or is not K or less. Responsive to a determination that the number of objects contained in the categorized subsection and all sub-nodes thereof is K or less, the objects contained in the categorized subsection and all sub-nodes thereof are retrieved and such objects are returned as the K nearest neighbors to the query object. Responsive to a determination that the number of objects contained in the categorized subsection and all sub-nodes thereof is not K or less, an updated child node is selected in correspondence to the subsection closest to the first pivot object having a numerical value larger than the projection of the query object, and the aforementioned steps of projecting, categorizing and determining to the updated child node are recursively applied.

In some of these example embodiments, the steps of projecting, categorizing and determining are recursively applied to sequential updates of the child node until a determination that the number of objects contained in the categorized subsection and all sub-nodes thereof is K or less.

HFM Tree Build Algorithm

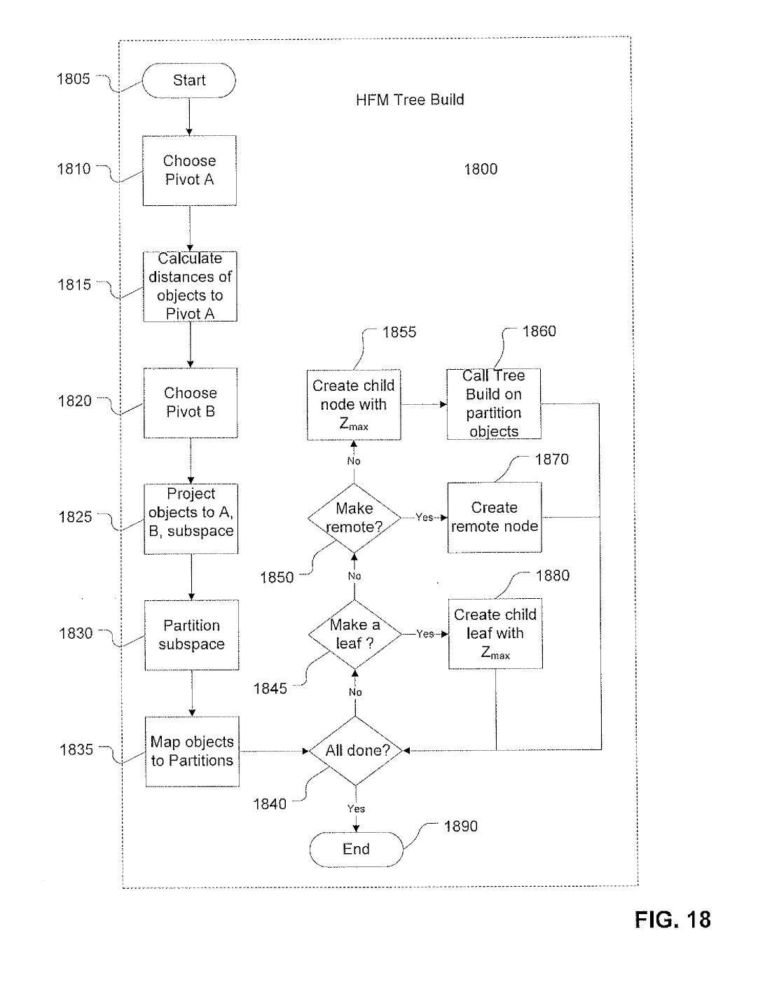

Some example embodiments of the HFM Tree Build Algorithm are illustrated in FIG. 18. While FIG. 18 shows one example embodiment, it should be appreciated that many other embodiments exist, including ones similar to FIG. 18 in which some processing blocks are removed, inserted, and reordered. The HFM Tree Build algorithm 1800 starts from a block 1805 with a set of objects. PivotA is an object from the set chosen at random at a block 1810. A distance from PivotA to every other point is computed using a metric at a block 1815. PivotB is chosen at a block 1820 to be, for example, an object with a maximum distance from PivotA. Alternatively, PivotB is chosen at a block 1820 to be an object that is in a predefined percentile of the maximally distant objects from PivotA. In a third alternative, PivotB is chosen at a block 1820 at random with a bias in the selection based on the distance from PivotA. For each object, a distance to PivotB is computed. The projection Zi onto the PivotA, PivotB subspace is computed for each point Xi at a block 1825, where

$${Z}_{i} = \frac{{d}_{a , i}^{2} + {d}_{a , b}^{2} - {d}_{b , i}^{2}}{2 {d}_{a , b}}$$

where d_{a,i} and d_{b,i} are the distances according to the metric from Xi to PivotA and PivotB respectively and d_{a,b} is the distance from PivotA to PivotB.

Z is partitioned into M subsets or less at a block 1830, where the subsets are, for example, of approximately equal size. For each subset it is determined that the z values for all the subset objects are the same (or less than some number of objects) at a block 1840 and at a block 1845, then a child leaf node is made that contains a list of each object in this subset at a block 1880, and the z value in the leaf node is saved as Zmax. In some embodiments, if the tree is sufficiently deep, a child leaf is made for every partition (at the block 1845, the block 1845 and the block 1880). However, if a leaf node is not made at a block 1845, then it is considered whether to create the child node as a remote tree at a block 1850. A remote tree can be made at a block 1870, for example, if the current node tree depth is at a pre-specified level. By creating remote nodes, tree creation can further be distributed across multiple processors or machines. If the system decides not to make a remote node at block 1850, then a child node on this subset of objects is created with the maximum z value in the child node (or infinity if this is the last subset) at a block 1850 and the leaf node is saved as Zmax at a block 1855. The Tree Build Algorithm is run on the subset at a block 1860. Once it is determined that every child partition is processed at a block 1840, the Tree Build algorithm returns (ends) at block 1890.

The partitioning of the z-values described above is performed to maximally distribute the data. However, in other example embodiments, 1-dimensional clustering can be used to try to split the data into more natural clusters of the data. This approach can minimize the probability of cluster overlap and result in a more efficient search time although the tree may not be as balanced.

In order to search for the k-nearest neighbors of a query object using the tree of objects, at each node, the query object can be put into one of the M child subsets. This is accomplished by computing a z value for the object using the node's pivot points and then finding the subset partition to which z belongs.

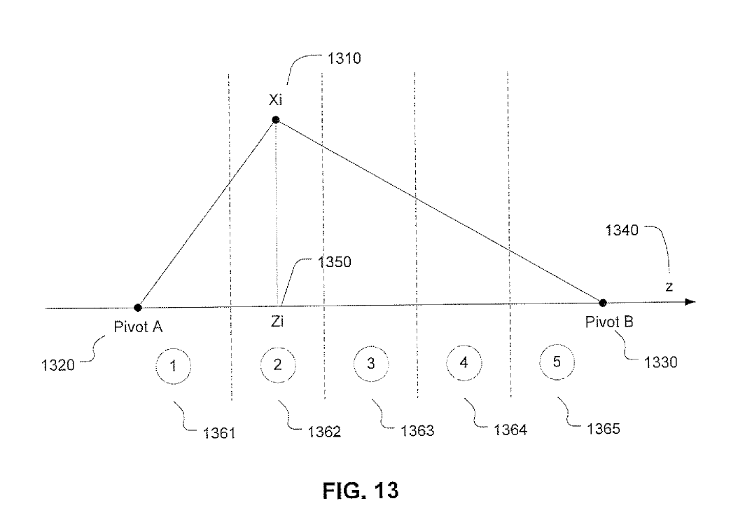

FIG. 13 illustrates the partitioning of a tree node into 5 partitions 1361 through 1365. An object Xi 1310 is projected onto a subspace 1340 defined by Pivot points A 1320 and B 1330. The subspace 1340 is partitioned into several regions 1361 through 1365 based on the projection value z. The distance of object Xi 1310 to any other point not in partition j, where j is not the same partition of the object, is, by the triangle inequality, at least min(|Zmax[j]−Zi|, |Zmax[j−1]−Zi|). In FIG. 13, for example, the object Xi 1310 is projected according to the pivot points 1320 and 1330 to value Zi 1350 on the z axis 1340 which falls into the second partition 1362 of z.

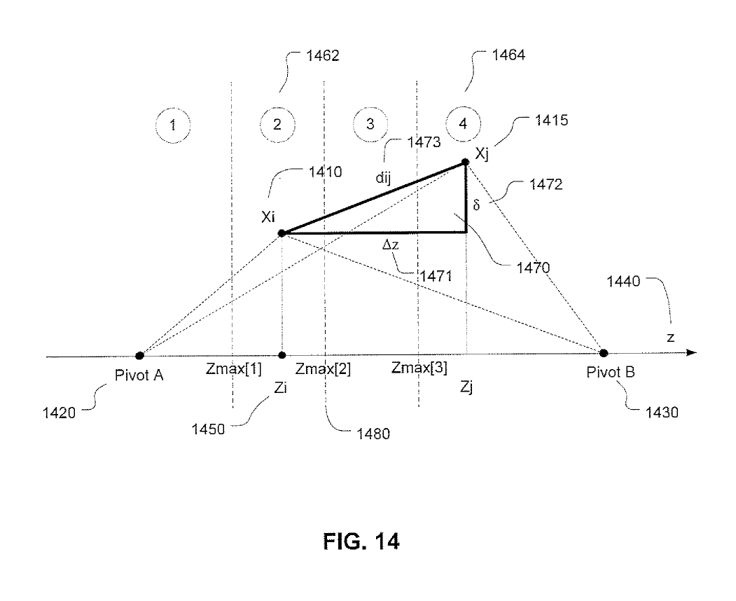

FIG. 14 shows any point Xj 1415 in partition 4 1464. In this example, a right triangle 1470 is formed with sides of lengths of Δz 1471 (the distance in the Pivot A B 1420 and 1430 projection space 1440) and δ 1472 and with a diagonal of length d_{i,j} 1473. Any object projecting into a different partition than that of the Xi 1410 projected partition 1462 will be at least the z distance of the nearest partition boundary 1480 to Zi 1450. This is because if Xj 1415 is any point in the other partition, then it forms a right triangle with sides of lengths of Δz 1471 (the distance in the Pivot A B 1420 and 1430 projection space 1440) and δ 1472, and a diagonal of length d_{i,j} 1473. It is noted that

Δz≦d_{i,j}

And thus over the whole other partition d_{i,j} 1473 must be at least min(|Zmax[m]−Zi|, |Zmax[m−1]−Zi|) where m is the partition of Xj 1415.

This is an important observation because it sets a bound on how close an object in the space can be to a search object given its partitions at a node.

Returning to FIG. 14, d_{i,j} 1473 must be at least min(|Zmax[4]−Zi|, |Zmax[3]−Zi|) which, in this example, implies that d_{i,j} 1473 must be at least Zmax[3]−Zi.

For the search strategy, starting at the root node, each child node is put into a priority queue to be further explored. The priority queue uses the distance to the partition (or cluster) as the value used to prioritize the search. Closer clusters to the search object are examined before farther clusters. In the strategy, the minimum distance to a partition is used to prioritize the search nodes. If the object is known to fall within a particular node partition, then the minimum distance to this node is zero and this node would be given top priority.

An alternative to this strategy is to use a model which estimates the probability of a partition containing nearest neighbors given the current k-th nearest neighbor or a projection of the k-th nearest neighbor. The probability may be efficiently estimated in the sub-space of z-values. Based on this probability, the number of nearby neighbors that might be found in a partition is estimated and then the search strategy is prioritized (i.e., the priority value is set for the priority queue) so that partitions are prioritize by the estimate of the probability that they contain nearby neighbors. In order to accomplish this, the marginal sub-space probability distribution is estimated and then the probability of observing a nearby neighbor given the number of objects in a partition and the current k-th neighbor distance search radius is estimated.

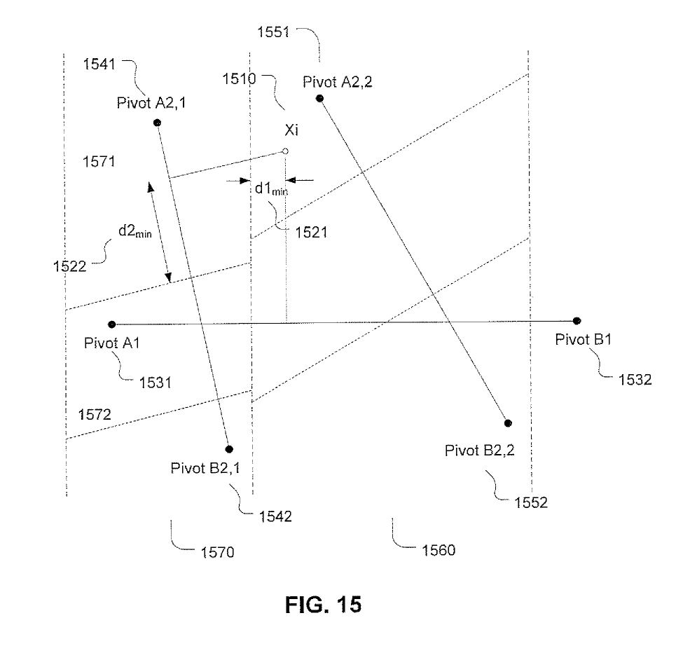

When the nodes on the top of the priority queue are examined, the above process is repeated and any child nodes may be added to the priority queue. The minimum distance to a partition represented by a sub-node is the greater of 1) the minimum pivot-projected distance to the partition for that node or 2) the minimum distance of the point to the parent node, as explained by FIG. 15. A set of objects is partitioned first based on Pivot A1 1531 and Pivot B1 1532. Then the 2nd partition 1560 (or more generally the m-th partition) is partitioned into partitions based on Pivot A2,2 1551 and Pivot B2,2 1552 (or more generally A2,m and B2,m). Even though the search object Xi 1510 projects into the first partition 1571 (top left region) from the Pivot A2,1 1541 and Pivot B2,1 1542 generated partition 1570, it is known from the parent node that Xi 1510 is at least d1ₘᵢₙ distance 1521 from any point in the first sub-partition of the Pivot A1 1531 to Pivot B1 1532 generated partitioning. However, the minimum distance to partition 1572 (left-center region) from the search object Xi 1510 is the min-z-distance of the Pivot A2,1 1541 and Pivot B2,1 1542 generated partitioning of partition 1570. This minimum distance is given by d2ₘᵢₙ 1522.

The root node has a minimum distance of zero bound to the query point.

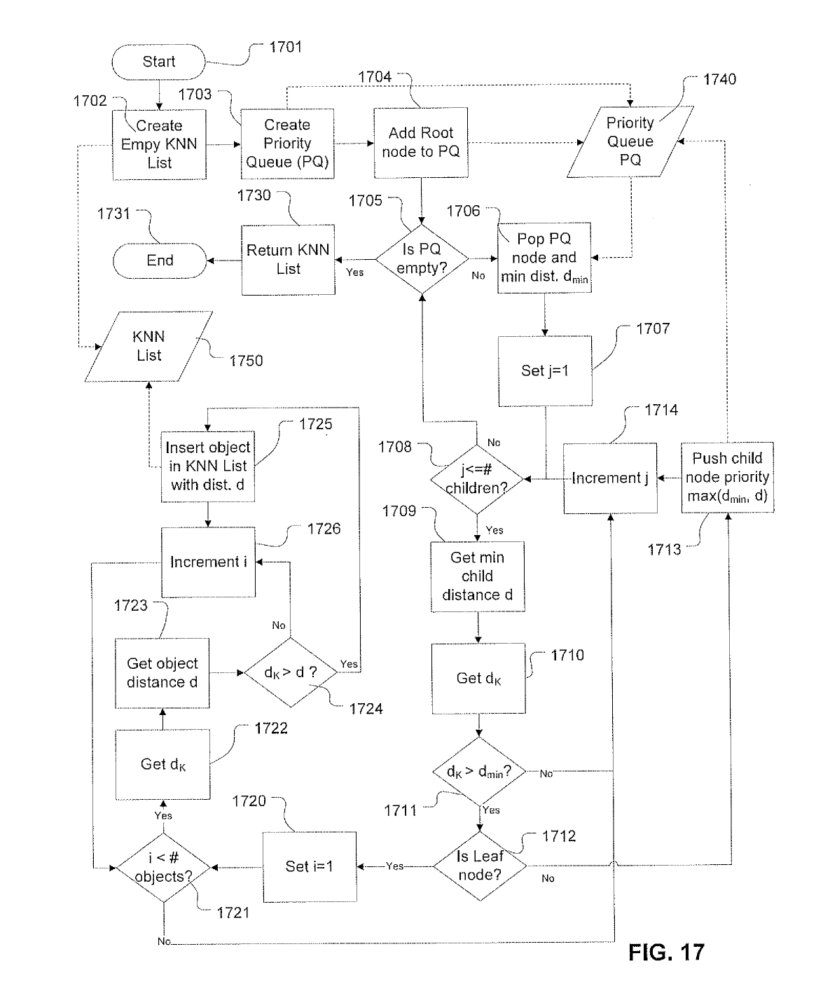

An example embodiment of the basic search algorithm is shown in FIG. 17 and is described below. Of course, there are variations of the search algorithm, some of which, for example, can be used to take advantage of parallel and distributed systems.

Basic Search Algorithm

In FIG. 17, the search starts from a block 1701 and an empty K-nn list 1750 is created at a block 1702, the K-nn list being an ordered list of maximum length K. This list will store the K-nearest neighbor candidates. A priority queue 1740 of node and distance is created at a block 1703 where priority is given to smaller distances. The root tree node is added at a block 1704 to the priority queue with a distance of zero (this is the minimum distance a search object can be from this node).

Next, a priority queue iteration is started while priority queue is not empty or no other stop condition is met at a block 1705. A node is popped off the top of the queue at a block 1706. Counter j is set to 1 at a block 1707 and then a determination is made that j is less than or equal to the number of children of the popped node at a block 1708.

If it is determined that j is less than or equal to the number of children of the popped node, the minimum z-distance to the child node is calculated based on the parent node's z-distance of the query object to the closest partition border z-value at a block 1709. If the query object's z-value places it in the child node's z-range, then the min-z-distance is zero. The distance to the Kth item in the K-nn list is retrieved at a block 1710. If the K-nn list contains less than K elements the distance is given as infinity. If the min z-distance is greater than or equal to the Kth item distance then j is incremented at a block 1714 and at a block 1708, it is determined if there are more children of the popped node to consider. If it is determined that the min-z-distance is less than the Kth item in the K-nn list at a block 1711, and if it is determined that the child node is not a leaf node at a block 1712, the min-distance to the query object is set to be the maximum of the min-distance of the parent node (the popped distance) or the min-z-distance calculated above based on the z-value, and this child node is added to the priority queue with the min-distance calculated above at a block 1713.

The counter j is incremented at a block 1714 and then in a block 1708, it is determined if there are more children of the popped node to consider. On the other hand, if the min-z-distance is less than the Kth item at a block 1711 in the K-nn list at a block 1725 (or if the list is not fully populated), and if the child node is a leaf node at a block 1712, then the distance(s) to the leaf object(s) is calculated, and the leaf object(s) with their respective distance(s) is added at a block 1720 through 1726 to the K-nn list 1750. Objects are added at a block 1725 to the K-nn list 1750 when their distance to the query object is less than the distance of the K-th item in the list or when the list is not fully (K objects) populated at a block 1724.

Once all of the leaf objects are considered for the K-nn list at a block 1750, as determined by the block 1721, control is returned to block 1714 where j is incremented and then in a block 1708 it is determined if there are more children of the popped node to consider. Once all the child nodes of the popped node have been processed at the block 1708 the control returns to the block 1705 and the priority queue is checked for the next node to process.

If it is determined that there are still nodes at block 1705 in the priority queue 1740 and if no stopping conditions have been met, a node is again popped at the block 1706 and the process of evaluating the nodes children is repeated for the newly popped node. If the priority queue 1740 is empty or another stopping condition has been met at the block 1705, control is passed to a block 1730 where the K-nn list 1750 is returned. Then the search terminates at the block 1731.

The above algorithm can be modified to stop searching after one or more of the following conditions have been met: (1) a certain number of child nodes have been visited, (2) the Kth nearest neighbor has not changed in several iterations, and (3) a fixed amount of time processing time has elapsed.

Another example embodiment in which the distance measure is not a true metric, in the sense that the triangle inequality does not necessarily hold, is also considered. In this example embodiment, the algorithm can still be used to approximate the K-nearest neighbors when the triangle inequality approximately holds, if the above algorithm is modified such that the exploration of some nodes is not rejected outright. These nodes may still be added to the priority queue. However, they will be given lower priority when searching and may not be ever explored when using non-exhaustive search stopping conditions like the ones described above, for example.

Additionally in a distributed system described above, the tree/hierarchy can be broken into a top level hierarchy and several lower level hierarchies. The system can choose the best top level hierarchy child nodes.

FIG. 16 is a high level diagram explaining an example embodiment of the processing and data flow of the proposed distributed index creation framework. The distributed index creation framework may be based on a Map-Reduce design paradigm which, for example, can be executed on top of Apache's Hadoop Map-Reduce system.

In this embodiment, the distributed index creation system is composed of a Splitter 1601 having the primary responsibility to partition the Dataset 1607 into ‘S’ distinct Splits 1602. The Dataset 1607 may be composed of ‘N’ individual objects or rows. Each Dataset 1607 object may contain, for example, zero or more image features, the original image location, and an identifier denoting a unique image id. In some embodiments, the features for the image are not pre-calculated and stored in the Dataset 1607. Instead, the features may be calculated in one or more of the Mappers 1603

Once the Splits 1602 have been identified they are assigned to the Mapper tasks 1603 by the Map-Reduce system. The main responsibility of the Mapper 1603 is to map all of the Dataset 1607 objects that are part of a given Split 1602 to given Index Bucket 1606 or 1609, for example, which is identified by a bucket-id. This is accomplished via the IndexGenerator 1604 which takes as an input a single Dataset 1607 object and assigns it to a particular bucket-id 1606 or 1609 for example. This assignment is index specific; for example, HK means based IndexGenerator 1604 will assign a given Dataset object to the closest HK means sub-tree. The IndexGenerator 1604 may optionally perform image feature calculations and transformations by calculating image features and/or combining, normalizing, etc. the given and calculated image feature(s) such that a resulting feature meets the requirements of the particular indexing scheme. As an example, a global edge histogram image feature may be normalized by dividing by its L2 norm and concatenated with a global color histogram image feature divided by its L2 norm. The result may be again normalized, and the resulting vector may be used as the resulting feature to be used for generating the index. In another example, the color feature may only be used when the edge histogram indicates a lack of strong edge content in the image, and thus it may be computationally beneficial to conditionally calculate the color feature in the index generator only when necessary. It should be appreciated that many more such transformations are possible.

The output of the mapper 1603 is a bucket-id and a Dataset object key-value pair. The output of Mapper(s) 1603 is then sorted/grouped 1610 and assigned 1611 to a given Reducer 1605 or 1608 by the Map-Reduce system. In practice, many more Reducers are possible. The input to each Reducer 1605 and 1608 is a collection of individual Dataset objects that have been mapped to a particular bucket-id by the plurality of the Mapper 1603 tasks. Each Reducer 1605, 1608, etc., may handle a plurality of bucket-id's. Typically, each Reducer handles the bucket-id's one-by-one until all bucket-id's have been processed.

The IndexGenerator 1604, given a particular bucket-id, creates instances of the Index Buckets 1606 and 1609. The Reducers 1605 and 1608 then write the individual Dataset objects or references thereof to a given Index Bucket 1606 or 1609. In practice, each Reducer may write to multiple Index Buckets, i.e. in total one for each bucket-id. Each Index Bucket may internally create the appropriate sub-index data structure if appropriate for the particular indexing scheme embodiment. For example, in one embodiment using HK-means, if the Index Bucket contains sufficiently many Dataset objects, then an index creation process may be recursively created for these objects. On the other hand, if the number of Dataset objects in the Index Bucket is small then no further indexing of the objects is done.

### Other Embodiments

According to other embodiments contemplated by the present disclosure, example embodiments may include a computer processor such as a single core or multi-core central processing unit (CPU) or micro-processing unit (MPU), or a Graphical Processing Unit (GPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU), or a graphical processing unit (GPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

1. A method in a central data processing node for indexing a data set of objects, the method comprising:
partitioning the data set into plural work units each with plural objects;
distributing the plural work units to respective ones of multiple data processing nodes, wherein each data processing node maps the plural objects in corresponding work units into respective ones of given sub-indexes; and
constructing a composite index for the objects in the data set by reducing the sub-indexes respectively, wherein reducing the sub-indexes respectively is distributed among multiple data processing nodes.

2. A method according to claim 1, wherein the mapped data objects are received from at least one of the multiple data processing nodes, wherein the received mapped data objects are reduced.

3. A method according to claim 1, further comprising a pre-process in which a training tree is generated by performing a HK means algorithm on a sample of the data set.

4. A method according to claim 1, further comprising a pre-process in which a training tree is generated by performing a HFM algorithm on a sample of the data set.

5. A method according to claim 1, further comprising a pre-process in which a hash function is defined.

6. A method according to claim 1, wherein the multiple data processing nodes reduce the sub-indexes by performing a HK means algorithm on the mapped objects.

7. A method according to claim 1, wherein the multiple data processing nodes reduce the sub-indexes by performing a HFM algorithm on the mapped objects.

8. A method according to claim 1, wherein the multiple data processing nodes reduce a sub-index by assigning the mapped objects to a bucket.

9. A method according to claim 1, further comprising a post-process phase in which the composite index is updated based on updated statistics received from the multiple data processing nodes.

10. A method according to claim 1, further comprising a post-process phase in which the composite index is rebalanced.

11. A method according to claim 1, wherein each of the plural work units has approximately the same number of plural objects.

12. A method according to claim 1, further comprising a phase in which at least one feature vector is derived for each object in the data set, and wherein the composite index comprises an index based on the at least one feature vector.

13. A method for searching a composite index which indexes a data set of plural objects, comprising:
accessing a composite index constructed according to the method of claim 1;
receiving a query object; and
searching the composite index to retrieve K most similar objects to the query object.

14. A method according to claim 13, wherein searching the composite index is distributed among multiple data processing nodes.

15. A computer-readable storage medium on which is stored computer-executable process steps for causing a computer to execute the method according to claim 1.

16. A method in a data processing node for indexing a data set of objects, the method comprising:
receiving plural work units from a central data processing node, wherein the central data processing node partitions the data set into the plural work units with plural objects and distributes the plural work units to respective ones of multiple data processing nodes;
mapping the plural objects in corresponding work units into respective ones of given sub-indexes; and
reducing the sub-indexes, wherein the central data processing node constructs a composite index for the objects in the data set by reducing the sub-indexes respectively, and wherein reducing the sub-indexes respectively is distributed among multiple data processing nodes.

17. A method according to claim 16, further comprising receiving the mapped data objects from at least one of the multiple data processing nodes, wherein the received mapped data objects are reduced.

18. A method according to claim 16, wherein a training tree is generated by performing a HK means algorithm on a sample of the data set in a pre-process phase.

19. A method according to claim 16, wherein a training tree is generated by performing a HFM algorithm on a sample of the data set in a pre-process phase.

20. A method according to claim 16, wherein a hash function is defined in a pre-process phase.

21. A method according to claim 16, wherein the sub-indexes are reduced by performing a HK means algorithm on the mapped objects.

22. A method according to claim 16, wherein the sub-indexes are reduced by performing a HFM algorithm on the mapped objects.

23. A method according to claim 16, wherein the sub-indexes are reduced by assigning the mapped objects to a bucket.

24. A method according to claim 16, further comprising a post-process phase in which the composite index is updated based on updated statistics received from the multiple data processing nodes.

25. A method according to claim 16, further comprising a post-process in which the composite index is rebalanced.

26. A method according to claim 16, wherein each of the plural work units has approximately the same number of plural objects.

27. A method according to claim 16, wherein at least one feature vector is derived for each object in the data set, and wherein the composite index comprises an index based on the at least one feature vector.

28. A method for searching a composite index which indexes a data set of plural objects, comprising:
accessing a composite index constructed according to the method of claim 16;
receiving a query object; and
searching the composite index to retrieve K most similar objects to the query object.

29. A method according to claim 28, wherein searching the composite index is distributed among multiple data processing nodes.

30. A computer-readable storage medium on which is stored computer-executable process steps for causing a computer to execute the method according to claim 16.

31. A central data processing node for indexing a data set of objects, the central data processing node comprising:
a partition unit constructed to partition the data set into plural work units each with plural objects;
a distribution unit constructed to distribute the plural work units to respective ones of multiple data processing nodes, wherein each data processing node maps the plural objects in corresponding work units into respective ones of given sub-indexes;
a construction unit constructed to construct a composite index for the objects in the data set by reducing the sub-indexes respectively, wherein reducing the sub-indexes respectively is distributed among multiple data processing nodes.

32. A central data processing node according to claim 31, wherein at least a first one of the multiple data processing nodes receives the mapped data objects from at least a second one of the multiple data processing nodes, wherein the received mapped data objects are reduced by the at least first one of the multiple data processing nodes that receives the mapped objects.

33. A central data processing node according to claim 31, further comprising a pre-process unit constructed to generate a training tree by performing a HK means algorithm on a sample of the data set.

34. A central data processing node according to claim 31, further comprising a pre-process unit constructed to generate a training tree by performing a HFM algorithm on a sample of the data set.

35. A central data processing node according to claim 31, further comprising a pre-process unit constructed to define a hash function.

36. A central data processing node according to claim 31, wherein the multiple data processing nodes reduce the sub-indexes by performing a HK means algorithm on the mapped objects.

37. A central data processing node according to claim 31, wherein the multiple data processing nodes reduce the sub-indexes by performing a HFM algorithm on the mapped objects.

38. A central data processing node according to claim 31, wherein the multiple data processing nodes reduce a sub-index by assigning the mapped object to a bucket.

39. A central data processing node according to claim 31, further comprising a post-process unit constructed to update the composite index based on updated statistics received from the multiple data processing nodes.

40. A central data processing node according to claim 31, further comprising a post process unit constructed to rebalance the composite index.

41. A central data processing node according to claim 31, wherein each of the plural work units has approximately the same number of plural objects.

42. A central data processing node according to claim 31, further comprising a feature unit constructed to derive at least one feature vector for each object in the data set, and wherein the composite index comprises an index based on the at least one feature vector.

43. A central data processing node for searching a composite index which indexes a data set of plural objects, comprising:
an accessing unit constructed to access a composite index constructed by the node of claim 31;
a reception unit constructed to receive a query object; and
a searching unit constructed to search the composite index to retrieve K most similar objects to the query object.

44. A central data processing node according to claim 43, wherein searching the composite index is distributed among multiple data processing nodes.

45. A data processing node for indexing a data set of objects, comprising:
a receiving unit constructed to receive plural work units from a central data processing node, wherein the central data processing node partitions the data set into the plural work units with plural objects and distributes the plural work units to respective ones of multiple data processing nodes;
a mapping unit constructed to map the plural objects in corresponding work units into respective ones of given sub-indexes; and
a reducing unit constructed to reduce the sub-indexes, wherein the central data processing node constructs a composite index for the objects in the data set by reducing the sub-indexes respectively, and wherein reducing the sub-indexes respectively is distributed among multiple data processing nodes.

46. A data processing node according to claim 45, further comprising a second receiving unit constructed to receive the mapped data objects from at least a second one of the multiple data processing nodes, wherein the received mapped data objects are reduced by the reducing unit.

47. A data processing node according to claim 45, wherein a training tree is generated by performing a HK means algorithm on a sample of the data set in a pre-process phase.

48. A data processing node according to claim 45, wherein a training tree is generated by performing a HFM algorithm on a sample of the data set in a pre-process phase.

49. A data processing node according to claim 45, wherein a hash function is defined in a pre-process phase.

50. A data processing node according to claim 45, wherein the sub-indexes are reduced by performing a HK means algorithm on the mapped objects.

51. A data processing node according to claim 45, wherein the sub-indexes are reduced by performing a HFM algorithm on the mapped objects.

52. A data processing node according to claim 45, wherein the sub-indexes are reduced by assigning the mapped objects to a bucket.

53. A data processing node according to claim 45, further comprising a post-process unit constructed to provide updated statistics for updating the composite index.

54. A data processing node according to claim 45, further comprising a post process unit constructed to provide rebalance information for rebalancing the composite index.

55. A data processing node according to claim 45, wherein each of the plural work units has approximately the same number of plural objects.

56. A data processing node according to claim 45, wherein at least one feature vector is derived for each object in the data set, and wherein the composite index comprises an index based on the at least one feature vector.

57. A data processing node for searching a composite index which indexes a data set of plural objects, comprising:
an accessing unit constructed to access a composite index constructed by the node of claim 45;
a third receiving unit constructed to receive a query object; and
a searching unit constructed to search the composite index to retrieve K most similar objects to the query object.

58. A data processing node according to claim 57, wherein searching the composite index is distributed among multiple data processing nodes.
